(19) United States
(12) Patent Application Publication
(10) Pub. No.: US 2012/0057916 A1
(43) Pub. Date: Mar. 8, 2012

(54) PRINT ASSEMBLY AND CORRESPONDING USE

(75) Inventor: Patrick Lepeltier, Angicourt (FR)

(73) Assignee: GOSS INTERNATIONAL MONTANAIRE SA, Montataire (FR)

(21) Appl. No.: 13/227,094

(22) Filed: Sep. 7, 2011

(30) Foreign Application Priority Data
Sep. 7, 2010 (FR) 10 57098

(51) Int. Cl. B41J 15/04

(52) U.S. Cl. 400/611

(57) ABSTRACT

A print assembly including an upstream print unit and a downstream print unit adapted to print, one after the other, a strip to be printed over a print width. Each upstream and downstream print unit defining a print interstice and the two print interstices defining an interstice plane. The two upstream and downstream print units defining a middle line. The print assembly includes a compensator having at least one compensation path between the upstream and downstream print units for a partial strip of the strip to be printed. Each compensation path is longer than a neutral path for a neutral portion of the strip to be printed.

This application claims priority to French application FR 10 57098, filed on Sep. 7, 2010, the entire disclosure of which is incorporated by reference herein.

The present invention relates to a print assembly of the type comprising: an upstream print unit and a downstream print unit adapted to print, one after the other, a strip to be printed over a print width, each upstream and downstream unit defining a print interstice and the two print interstices defining an interstice plane, the two upstream and downstream print units defining a middle line.

### BACKGROUND

Offset printing presses are known having two print units that print one after the other on a strip of paper, each print unit printing with a different color.

These printing presses create a printing flaw known as “chevron” that consists of not exactly superimposing all of the colors needing to produce a same colored dot in the direction of travel of the paper both at the center of the strip and at the ends.

In fact, the upstream print unit takes the paper uniformly over the width thereof, while the downstream print unit takes more paper at the side edges than the center. As a result, the strip is more strained on the side edges and the dots to be printed by the downstream print unit are printed early relative to the center of the strip. This printing flaw is indicated in FIG. 11. The image to be printed by each print unit is a straight line extending through the width of the strip. The printed color C1 is that of the upstream print unit and is straight. The printed color C2 is that of the downstream print unit and one can see that the image is deformed, with the side portions ahead.

Under other circumstances, the upstream print unit takes more paper at the edges, while the downstream print unit takes it uniformly. In that case, the dots to be printed by the downstream print unit are printed late on the edges relative to the center of the strip. The same is true if the upstream print unit takes the paper uniformly and the downstream print unit takes it less on the edges. The latter case is shown in FIG. 12. The image printed by the upstream print unit is straight, while the image printed by the downstream print unit is late on the side edges. FIG. 13 shows another type of flaw, in the case where a first part of a blanket situated away from the edge and the middle line takes more and a second part of a blanket situated away from the edge and the middle line takes less than the parts directly adjacent to said parts. The printing flaw is therefore a zigzag-shaped flaw.

### SUMMARY OF THE INVENTION

An object of the invention is to provide a printing press that has an improved print quality and makes it possible to decrease or even eliminate the chevron effect, described above relative to the known presses, and preferably with simple and cost-effective means.

To that end, the invention provides a print assembly of the aforementioned type, characterized in that the print assembly comprises compensating means having at least two separate bypass members, each bypass member defining a compensation path between the upstream and downstream print units for a partial strip of the strip to be printed, and each compensation path is longer than a neutral path for a neutral portion of the strip to be printed.

According to specific embodiments, the print assembly according to the invention has one or more of the following features:

the neutral path is a path of the band to be printed freely suspended between the upstream and downstream print units;

the print width is formed by two printing half-widths;

at least two compensation paths defined by the bypass members are found on a same first printing half-width; and

[a] either for two of these compensation paths on said first printing half-width each time, the compensation path closest to the neutral portion is shorter than the compensation path furthest from the neutral portion;

[b] or for two of these compensation paths on said first printing half-width each time, the compensation path closest to the neutral portion is longer than the compensation path furthest from the neutral portion;

[c] or three compensation paths are found on the first printing half-width and the middle compensation path is longer than the other two of said three compensation paths;

at least two compensation paths defined by the bypass members are located on a same second printing half-width; and

[a] either for two of these compensation paths on said second printing half-width each time, the compensation path closest to the neutral portion is shorter than the compensation path furthest from the neutral portion;

[b] or for two of these compensation paths on said second printing half-width each time, the compensation path closest to the neutral portion is longer than the compensation path furthest from the neutral portion;

[c] or three compensation paths are found on the second printing half-width and the middle compensation path is longer than the other two of said three compensation paths;

and wherein in particular the compensation paths located on the first printing half-width being offset from a plane parallel to the interstice plane in a first direction and the compensation paths being located on the second printing half-width being offset from said plane parallel to the interstice plane in a second direction;

the neutral path is a path of a central portion of the strip to be printed;

the neutral path is a path of a side portion of the strip to be printed that is laterally offset from a central portion;

each bypass member is translationally mobile with a component perpendicular relative to the interstice plane, preferably is mobile independently of each other bypass member;

each bypass member is incliningly mobile relative to the interstice plane, in particular rotationally mobile around an incline axis extending parallel to the interstice plane and the middle line;

each bypass member extends over part of the printing width and is a bypass bar, a bypass roller or a bypass skate;

at least two bypass members have air outlet holes adapted to create an air cushion between the strip to be printed and the associated bypass member and in which the assembly has a supply device adapted to supply air only to the air outlet holes of the bypass members defining a compensation path, but not the air outlet holes of each bypass member not defining a compensation path;

the compensation means comprise at least one bypass counter-member arranged on the side of the strip opposite the bypass member, preferably laterally in the same position as the associated bypass member;

the bypass members are arranged at a sufficient distance upstream of the downstream print unit not to influence the side lay, in particular the distance between the print interstice of the upstream print unit and the bypass members is between 0% and 50% of the distance between the print interstices; and

a control device adapted to determine the longitudinal gap between the images printed by the upstream print unit and the downstream print unit and to act on the compensation means so that this gap is decreased or completely compensated.

The invention also relates to a use of an assembly as defined above, in order to correct an increasing longitudinal shift going from a central portion of the strip to be printed toward the two edges of the strip to be printed of two images printed consecutively by the upstream and downstream print units.

### BRIEF DESCRIPTION OF THE DRAWINGS

The invention will be better understood upon reading the following description, provided solely as an example and done in reference to the appended drawings, in which:

FIG. 1 is a diagrammatic top view of a printing press according to a first embodiment of the invention;

FIG. 2 is a diagrammatic cross-sectional view of the printing press along line II-II of FIG. 1;

FIG. 3 is a diagrammatic cross-sectional view of the printing press along line of FIG. 1;

FIG. 4 is a diagrammatic perspective view of part of the printing press of FIG. 1 in a configuration without compensation;

FIG. 5 is a view similar to the view of FIG. 4, the printing press being in a first compensation configuration;

FIG. 6 is a front view of the compensation device of the press in the first compensation configuration;

FIG. 7 is a view similar to the view of FIG. 4, the printing press being in a second compensation configuration;

FIG. 8 is a front view of the compensation device of the press in the second compensation configuration;

FIG. 9 is a view of a second embodiment of the printing press according to the invention, the view being similar to that of FIG. 5;

FIG. 10 is a front view of the second embodiment of the printing press according to the invention;

FIG. 11 is a view of a first printing flaw corrected by the compensation device according to the invention;

FIG. 12 is a view of a second printing flaw corrected by the compensation device according to the invention; and

FIG. 13 is a view of a third printing flaw corrected by the compensation device according to the invention.

### DETAILED DESCRIPTION

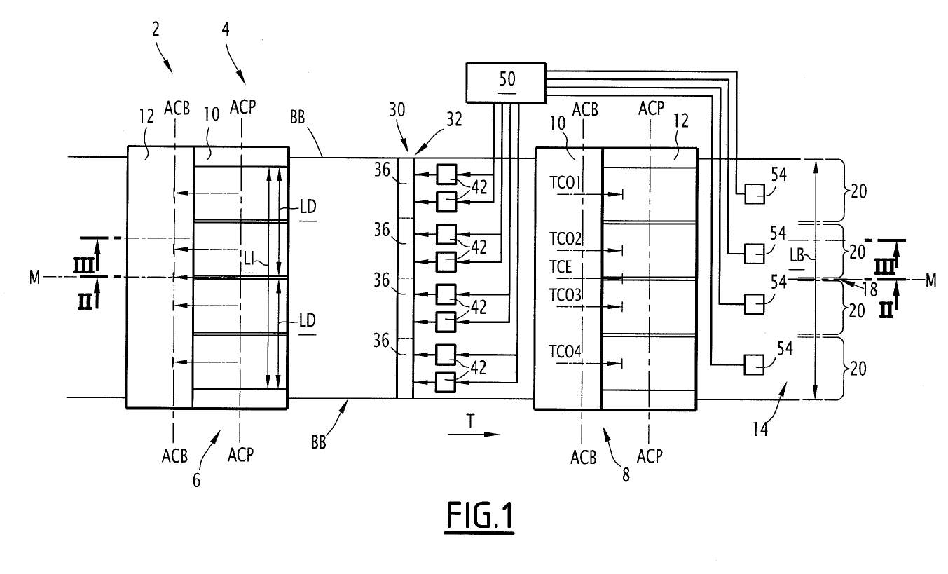

FIG. 1 shows a top view of a printing press according to the invention, designated by general reference 2.

The printing press 2 is an offset printing press.

The printing press 2 comprises a print assembly 4 provided with an upstream print unit 6 and a downstream print unit 8.

Each of the print units 6, 8 comprises two print groups provided with a plate cylinder 10 and a blanket cylinder 12. Alternatively, one of the plate cylinders per print unit can be omitted and the blanket cylinder 12 of that printing group therefore operates as an impression cylinder.

Each plate cylinder 10 has an axis of rotation ACP and each blanket cylinder 12 has an axis of rotation ACB.

The upstream print unit 6 and the downstream print unit 8 are adapted to print consecutively, one after the other over a strip to be printed 14 on a print width LI. The print width LI is divided into two printing half-widths LD. Each printing half-width is limited by one of two side edges BB (see below).

Each print unit 6, 8 defines a print interstice 16 through which the strip to be printed 14 passes. Each print interstice 16 is defined by the two blanket cylinders 12.

The two print interstices 16 define an interstice plane P-P passing through the two interstices.

In reality, the strip to be printed 14 is rolled lightly on the lower blanket at the output of the print unit due to the adhesion of the ink. For the purposes of this description, that effect is overlooked. The two print units 6, 8 also define a middle line M-M that extends in a middle plane of the two units and in the interstice plane P-P.

The strip to be printed 14 has a width LB slightly larger than the print width LI. The print assembly 4 defines a path for the strip to be printed 14 extending from the upstream print unit 6 toward the downstream print unit 8 in a direction of travel T.

The strip to be printed 14 has a central portion 18, a plurality of partial strips 20 and is defined by two side edges BB. The partial strips 20 extend laterally at the central portion 18. The central portion 18 is for example a portion extending between two printed images, but can have a lateral dimension of “0.”

It should be noted that the central portion 18 and the partial strips 20 are parts of the same strip to be printed 14, the strip to be printed 14 being continuous over the entire width thereof. The partial strips are therefore “virtual” strips. The print assembly 4 defines, for the strip to be printed 14, a plurality of paths extending between the print units 6, 8. Each path is the path traveled by an imaginary point on the strip to be printed 14 between the two print units 6, 8.

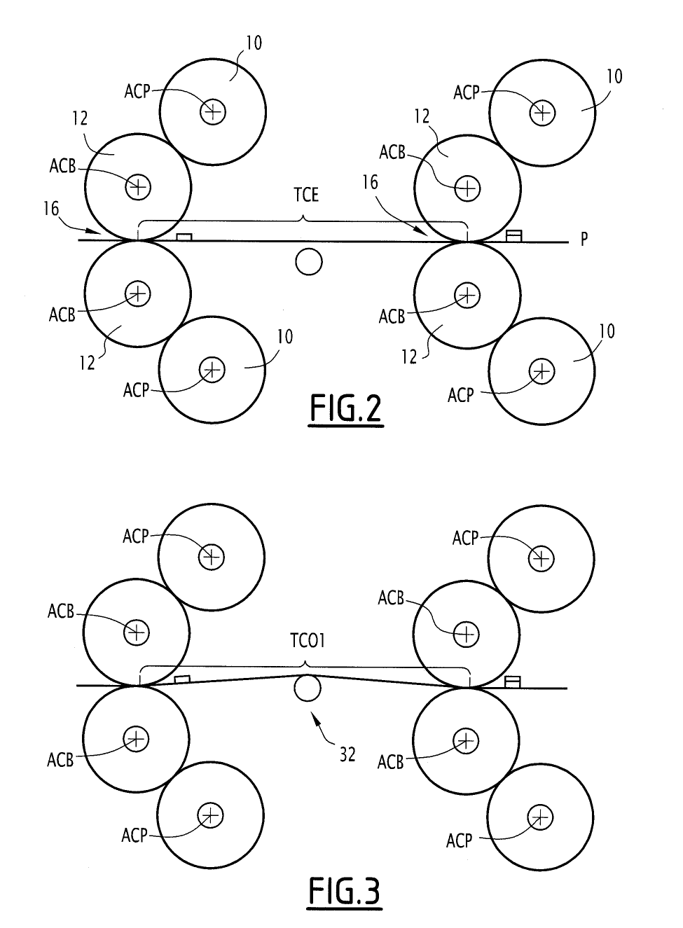

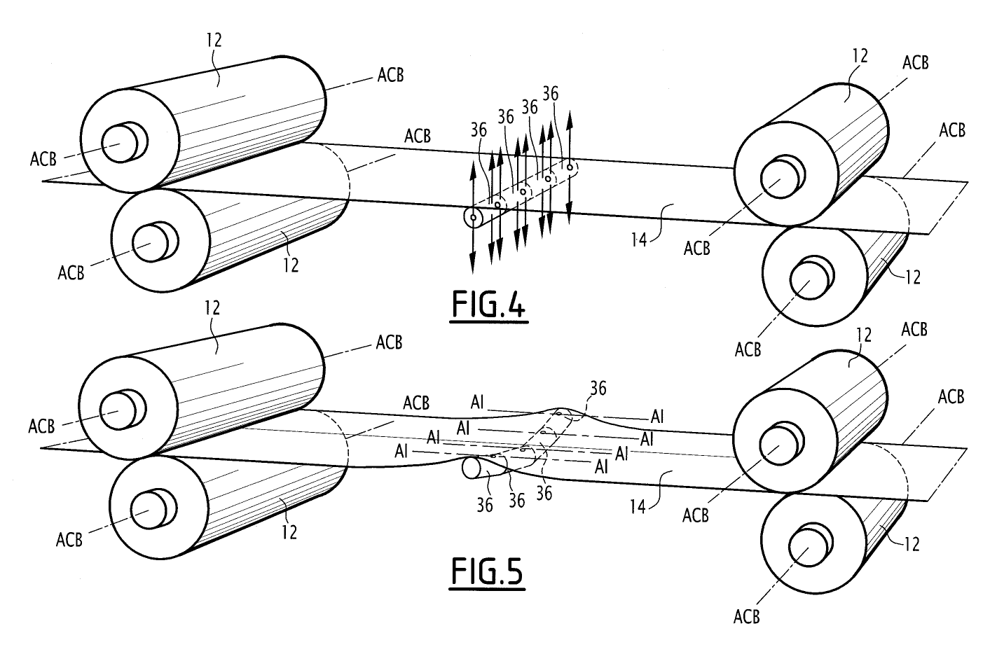

The printing press comprises compensation means 30 defining compensation paths for the strip to be printed, for example TCO1, TCO2, TCO3, TCO4, between the two upstream 6 and downstream 8 print units. The central portion 18 defines a central path TCE that is shown in FIG. 2.

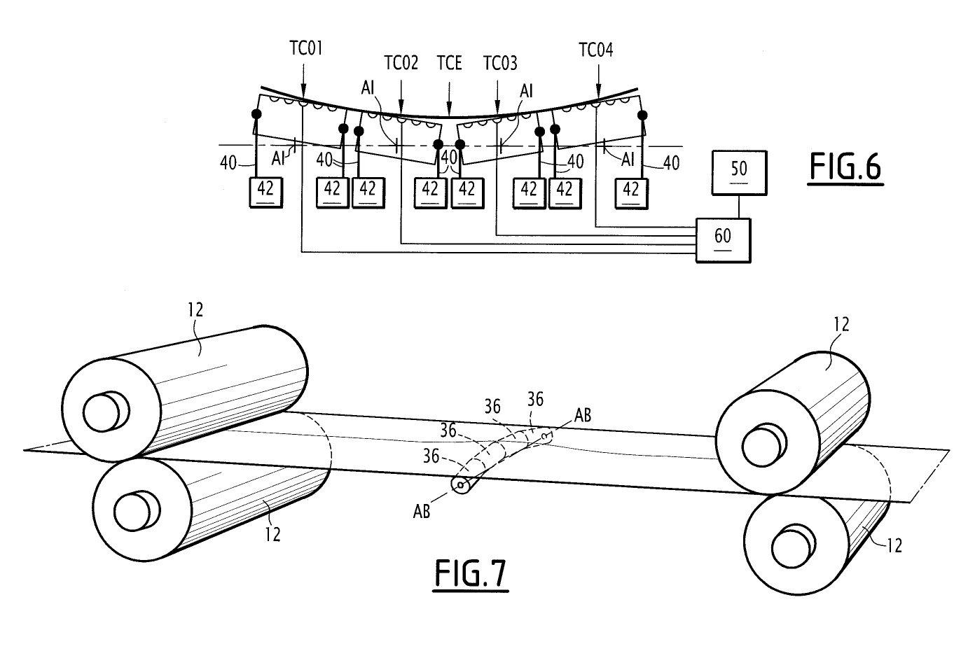

In the case of FIGS. 5 and 6, the compensation paths are longer than the central path TCE of the central portion 18 of the strip. The central path is a path freely suspended from the central portion 18 of the strip to be printed between the two upstream 6 and downstream 8 print units. The central path is therefore a neutral path and the portion 18 is a neutral portion. In the current case, the freely-suspended path coincides with the interstice plane P-P.

In other configurations of the compensation means 30, the neutral path can be at different locations of the central path.

The compensation means 30 comprise a bypass element 32 adapted to come into contact with the strip to be printed so as to bypass the desired portions of said strip. The bypass element 32 defines the compensation paths TCO1, TCO2, TCO3, TCO4.

The compensation paths TCO1, TCO2 are associated with a first of the printing half-widths LD and the compensation paths TCO3, TCO4 are associated with a second of the printing half-widths LD.

In the case of FIGS. 5 and 6, for two of these compensation paths TCO1, TCO2 or TCO3, TCO4 arranged on a same printing half-width LD each time, the compensation path closest to the central portion 18 is shorter than the compensation path furthest from the central portion. In other words, the compensation paths TCO2, TCO3 are shorter than the compensation paths TCO1, TCO4.

The bypass element 32 is an assembly of several bypass members 36. Each bypass member 36 extends over part of the width of the strip to be printed 14 or the printing width. Each bypass member 36 is adapted to bypass the partial strip 20 associated with the strip to be printed in order to define one or more compensation paths. In the case at hand, each of the bypass members 36 extends over a width substantially identical to the width of an image to be printed, a page to be printed or a printing plate.

In the case at hand, each of the bypass members 36 is a bypass bar. In the example shown in the figures, the bypass element 32 has four bypass members.

Each bypass member 36 is a separate piece from the other bypass members.

Each bypass member 36 is translationally mobile perpendicular relative to the interstice plane P-P, independently of all of the other bypass members 36. Alternatively, each bypass member 36 is translationally mobile in a direction having a component perpendicular to the plane P-P, independently of all of the other bypass members 36.

Furthermore, each bypass member 36 is incliningly mobile relative to the interstice plane P-P and in particular rotationally mobile around an incline axis AI (cf. FIG. 6), independently of all of the other bypass members 36.

In order to obtain the translational and incline mobility, the compensation means 30 comprise, for each bypass member 36, two support elements 40. Each end of each bypass member 36 is fastened to one of the two support elements 40. Each element 40 can be moved perpendicularly relative to the interstice plane P-P of all of the other support elements 40. The connection between the support element 40 and the associated end is obtained by an articulated joint, the axis of which is perpendicular to the middle line M-M.

The compensation means 30 also comprise, for each bypass member 36, two actuators 42 adapted to move one or both of the support elements 40 as a function of a control signal. There are two supports 40 per bypass member 36, and therefore two actuators 42 per bypass member 36.

The assembly 4 also comprises a control device 50. The control device 50 comprises, for each partial strip 20 or compensation path TCO1 to TCO4, a sensor 54 adapted to determine the longitudinal gap between an image printed by the upstream print unit 4 and the image printed by the downstream print unit 6 on the partial strip or the associated compensation path. Preferably, the reading of the longitudinal gaps is done for all colors downstream of the print unit furthest downstream.

In one alternative, one sensor 54 is arranged per partial strip 20 on each side of the strip and the measurement is done on the front and back of each partial strip, and an average of the two gap values determined for each partial strip 20 is calculated.

The control device 50 also comprises an evaluation and control unit that is adapted to send a control signal to the actuators 42 associated with the partial strip 20 or the compensation path and to move the bypass member 36 so that the longitudinal gap is decreased.

Each of the bypass members 36 also has, on the one hand, air outlet holes adapted to create an air cushion between the strip to be printed 14 and the bypass member 36, and on the other hand, a supply device 60 adapted to supply air only to the holes of the air outlet of the bypass members 36 defining a compensation path, but not the air outlet holes of each bypass member not defining a compensation path. In other words, the supply device 60 is adapted to supply air only to the air outlet holes of the bypass members that, in the absence of an air cushion, would be in contact with the strip to be printed.

The supply device 60 is to that end connected to the control device 50 and the air supply of the bypass member 36 is started or stopped by the device 50 as a function of the position and/or incline of the bypass members 36.

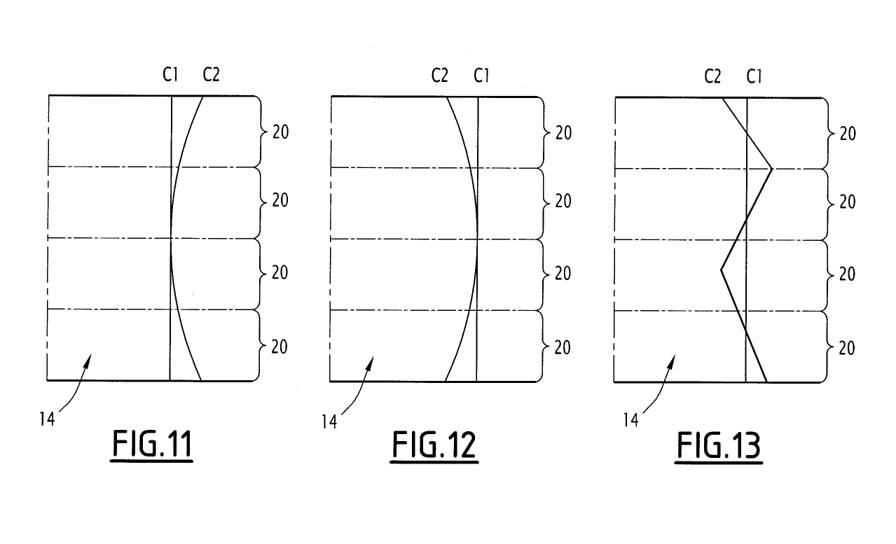

FIGS. 5 and 6 show an example of the position of the bypass members during a correction of a printing flaw corresponding to FIG. 11. One can see that the bypass members 36 associated with the correction path TCO2 and TCO3 are inclined relative to the interstice plane P-P, but that their ends associated with the central path TCE or neutral path are in a position in which the central path follows the neutral path and is not shifted from the interstice plane P-P. The members 36 associated with the correction path TCO1 and TCO4 are on the other hand inclined relative to the interstice plane P-P and are shifted toward the strip to be printed 14 so that the strip to be printed 14 is shifted from the interstice plane P-P.

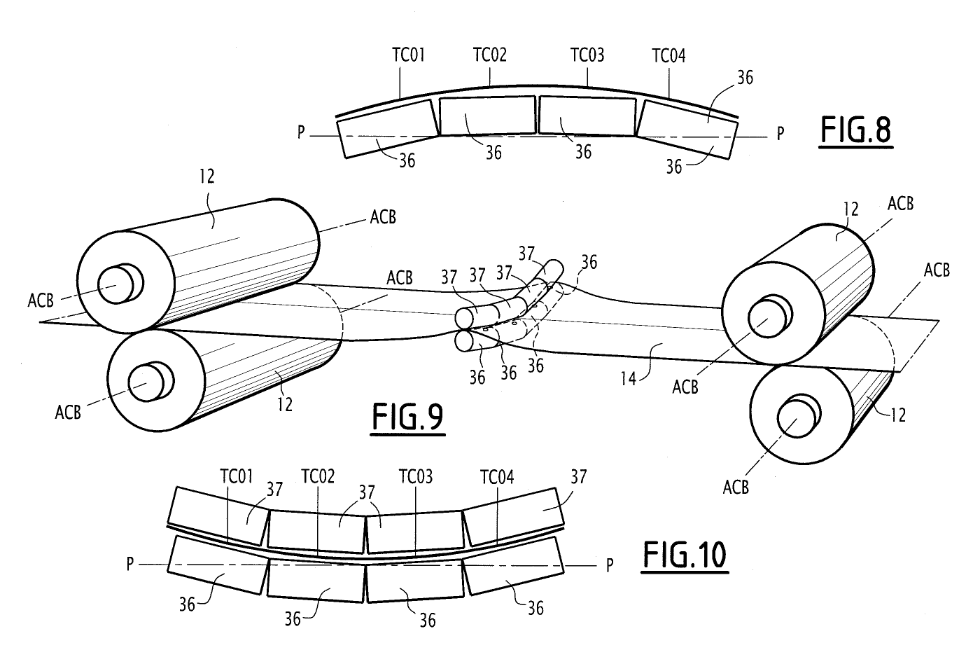

In FIGS. 7 and 8, the compensation means 30 are in a configuration for correcting a flaw of the type indicated in FIG. 12.

The bypass members 36 are configured so that the compensation paths TCO2 and TCO3 adjacent to the central path TCE are longer than the compensation paths TCO1 and TCO4 adjacent to the edges BB of the strip. Also, in that case, the central path TCE is longer than the compensation paths TCO1 to TCO4.

According to configurations that are not shown, the bypass members assume positions in which a printing flaw as indicated in FIG. 13 is corrected. In that case, the bypass members 36 define, for a first printing half-width, three adjacent compensation paths and the compensation path of the middle of these compensation paths is longer than the other two of these three compensation paths. Also, the bypass members 36 define, over a second printing half-width, three other compensation paths and the compensation path of the middle of these other compensation paths is longer than the other two of these other three compensation paths.

Furthermore, the compensation paths located on the first printing half-width are shifted from a plane parallel to the interstice plane (PI-PI), or coinciding with that plane, in a first direction and the compensation paths located on the second printing half-width are shifted from said plane in a second direction opposite the first direction.

Alternatively, the compensation paths located on the first printing half-width are shifted from a plane parallel to the interstice plane (PI-PI), or coinciding with said plane, in a first direction and the compensation paths found on the second printing half-width are shifted from said plane in the same direction.

Alternatively, the bypass members 36 are bypass rollers. In that case, each bypass member is formed by a bypass roller. Each bypass roller is rotationally mobile around an axis of rotation passing through the articulated joints of the support elements 40.

Also alternatively, each bypass member 36 is a bypass skate.

FIGS. 9 and 10 show a second embodiment of the invention, which differs from the embodiment previously described only by the following.

The compensation means 30 comprise, for at least one bypass member 36, and preferably for each bypass member, a bypass counter-member 37. Each bypass counter-member 37 is arranged on the side of the strip 14 opposite the bypass member 36, preferably laterally at the same position as the associated bypass member.

In general, the bypass members 36 are arranged at a sufficient distance upstream of the downstream print unit so as not to influence the side lay. To that end, the distance between the print interstice 16 of the upstream print unit and the bypass members is between 0% and 50% of the distance between the print interstices 16. Particularly, the distance between the print interstice 16 of the upstream print unit and the bypass members is between 25% and 50% of the distance between the print interstices 16. Preferably, the distance between the bypass members 36 and the print interstice 16 of the upstream or downstream print unit is between 30 cm and 50 cm.

According to Other Features of the Invention:

The central path is the shortest path of all of the paths of the strip to be printed between the upstream and downstream print units.

The compensation element 30 includes at least two bypass members 36 and each compensation path defined by the compensation member closest to the central portion 18 is shorter than each compensation path defined by the compensation member furthest from the central portion.

All of the bypass members 36 are arranged on a same side of the strip.

A print assembly is used so as to correct an increasing longitudinal shift going from a central portion of the strip to be printed toward the two edges of the strip to be printed of two images successively printed by the upstream and downstream print unit.

The gap of the second image relative to the first image is an advance continuously increasing going from the central part toward the two side edges of the strip.

The gap of the second image relative to the first image is a delay continuously increasing going from the central part toward the two side edges of the strip.

The compensation means are adapted to assume a configuration in which the strip of paper, at the compensation means and seen in cross-section through its entire width, has a curvature with the same sign over the entire width or forms at least one point of inflection on its width.

Each printing half-width comprises one edge of the strip of paper.

What is claimed is:

1-14. (canceled)

15. A print assembly of the type comprising:
an upstream print unit and a downstream print unit adapted to print, one after the other, a strip to be printed over a print width;
each upstream and downstream print unit defining a print interstice and the two print interstices defining an interstice plane;
the two upstream and downstream print units defining a middle line; and
a compensator having at least two separate bypass members, each bypass member defining a compensation path between the upstream and downstream print units for a partial strip of the strip to be printed, and each compensation path being longer than a neutral path for a neutral portion of the strip to be printed.

16. The print assembly according to claim 15 wherein the neutral path is a path of a band to be printed freely suspended between the upstream and downstream print units.

17. The print assembly according to claim 15 wherein
the print width is formed by first printing half-width and a second printing half-width;
at least two of the compensation paths defined by the bypass members are found on a same first printing half-width, and
[a] either for two of the compensation paths on the first printing half-width each time, a compensation path closest to the neutral portion is shorter than a compensation path furthest from the neutral portion,
[b] or for two of the compensation paths on the first printing half-width each time, the compensation path closest to the neutral portion is longer than the compensation path furthest from the neutral portion,
[c] or three compensation paths are found on the first printing half-width and a middle compensation path is longer than the other two of the three compensation paths.

18. The print assembly according to claim 17 wherein
at least two of the compensation paths defined by the bypass members are located on a same second printing half-width, and
[a] either for two of the compensation paths on the second printing half-width each time, the compensation path closest to the neutral portion is shorter than the compensation path furthest from the neutral portion,
[b] or for two of the compensation paths on the second printing half-width each time, the compensation path closest to the neutral portion is longer than the compensation path furthest from the neutral portion,
[c] or three compensation paths are found on the second printing half-width and the middle compensation path is longer than the other two of the three compensation paths,
wherein the compensation paths located on the first printing half-width offset from a plane parallel to the interstice plane in a first direction and the compensation paths located on the second printing half-width offset from the plane parallel to the interstice plane in a second direction.

19. The print assembly according to claim 15 wherein the neutral path is a path of a central portion of the strip to be printed.

20. The print assembly according to claim 15 wherein the neutral path is a path of a side portion of the strip to be printed that is laterally offset from a central portion.

21. The print assembly according to claim 18 wherein each bypass member is translationally mobile with a component perpendicular relative to the interstice plane.

22. The print assembly according to claim 18 wherein each bypass member is incliningly mobile relative to the interstice plane.

23. The print assembly according claim 15 wherein each bypass member extends over part of the printing width and is a bypass bar, a bypass roller or a bypass skate.

24. The print assembly according to claim 15 wherein at least two bypass members have air outlet holes adapted to create an air cushion between the strip to be printed and the associated bypass member and the assembly has a supply device adapted to supply air only to the air outlet holes of the bypass members defining the compensation path, but not the air outlet holes of each bypass member not defining the compensation path.

25. The print assembly according to claim 15 wherein the compensator further comprises at least one bypass counter-member arranged on a side of the strip opposite the bypass member.

26. The print assembly according to claim 15 wherein the bypass members are arranged at a distance upstream of the downstream print unit not to influence a side lay.

27. The print assembly according to claim 15 further comprising a controller adapted to determine a longitudinal gap between images printed by the upstream print unit and the downstream print unit and to act on the compensator decreasing or completely compensating the gap.

28. A method for using an assembly according to claim 15 comprising the step of correcting an increasing longitudinal shift going from a central portion of a strip to be printed toward two edges of the strip to be printed of two images printed consecutively by upstream and downstream print units.

29. The print assembly according to claim 21 wherein each bypass member is mobile independently of each of the other bypass members.

30. The print assembly according to claim 22 wherein each bypass member is rotationally mobile around an incline axis extending parallel to the interstice plane and a middle line.

31. The print assembly according to claim 25 wherein the at least one bypass counter-member is laterally in a same position as the associated bypass member.

32. The print assembly according to claim 26 wherein the distance between the print interstice of the upstream print unit and the bypass members is between 0% and 50% of the distance between the print interstices.
